(19) United States
(12) Patent Application Publication
(10) Pub. No.: US 2002/0183005 A1
(43) Pub. Date: Dec. 5, 2002

(54) Security codeless phone unit using bluetooth

(76) Inventors: Yi Sang Yl, Daejon-Shi (KR); Jong Jin Won, Daejon-Shi (KR); Byung Hwa Chang, Daejon-Shi (KR); In Ho Hwang, Daejon-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/155,399

(22) Filed: May 22, 2002

(30) Foreign Application Priority Data
May 24, 2001 (KR) 2001-28600

(51) Int. Cl. H04B 5/00

(52) U.S. Cl. 455/41; 455/410; 455/411

(57) ABSTRACT

The present invention relates to a security codeless telephone unit using bluetooth and communication method using the same. According to the present invention, a communication of a body of a codeless telephone in a portable device of a security codeless telephone with a portable device in a counterpart codeless telephone via a network is safely secured from a wiretapping. In order to accomplish this, the security codeless telephone unit according to the present invention includes the codeless telephone body and a portable device both of which are connected via bluetooth for allowing voice or data communication mode. Thus, if there is a request for switching a security mode from the portable device or the body, the portable device converts voice signals into encrypted digital signals using a voice codec, a vocoder and an encryption module. The portable device then transmits the encrypted digital signals to the body using the bluetooth the mode is changed from a voice communication mode to a data communication mode. Next, the body transmits the encrypted digital data to counterpart codeless telephone body and portable device via a network using a data modem. Therefore, the present invention can secure a safe communication from a wiretapping while securing the activity of a user.

### BACKGROUND OF THE INVENTION

1. Field of the Invention

The invention relates generally to a security codeless telephone unit having bluetooth, and more particularly to, a security codeless telephone unit in which a bluetooth having analog and digital signal processing units is included in a body and a portable device, respectively, whereby encrypted digital signals for allowing communication of a high security level are transmitted/received.

2. Description of the Prior Art

Conventional security equipments for telephone units mainly include an analog voice scrambler and a digital voice encryptor depending on its information protection mode.

In the analog voice scrambler mode, random numbers generated by a pseudo-random generator are employed to convert voice signals into respective elements such as a frequency region, a time region, etc., in order to prevent a wiretapper's wire tapping. In this mode, however, as the transmit band width is not extended upon transmission and there is a residual intelligibility existing even though the message is encrypted, there is a problem in the encryption degree, which thus results in reduced use of the analog voice scrambler mode.

On the other hand, in the digital voice encryptor mode, voices are converted into digital data. Then, random numbers generated by the pseudo-random generator are employed to perform a XOR operation on the digital data or reconstruct the digital data based on an encryption algorithm to convert them into noise shape. This mode is available in view of the degree of the mathematic difficulty. However, as analog voices become 64 kbps digital data if the analog voice is converted to digital data, this mode could not be applied to a public switched network (PSTN) being a narrow-band transmission path. Therefore, a digital voice compression technology using Vocoder and a narrow-band transmission path matching technology using a modem are currently applied to a digital voice encryptor used in the public switched network.

But, these types of the security equipments for the telephone unit are mainly applied to the wire telephone. Thus, they could not be applied to a codeless device. Due to this, though the degree of safety can be increased as the security telephone unit is used, there are problems that an efficiency of work is reduced and inconvenience is increased. Also, in view of the maintenance of the equipment, there is a problem that the security equipment itself must be kept in a safe place when the security equipment is not used and a common telephone unit must be connected in order to maintain the lines. In order to overcome these problems, there has been a proposed method of manufacturing an encryption module having a card shape. However, there is also a problem that this method must uses a contact type card whose effective range does not exceed that of the wire telephone unit.

The conventional codeless telephone unit includes an antenna for transmitting/receiving a high frequency to allow communication between body and portable devices, a duplexer for switching signals, modulator/demodulator for modulating/demodulating transmit/receive signals, a microphone for receiving/outputting voice, and a speaker, etc. The communication quality of this codeless telephone unit is directly influenced by the transmit/receive circuit between the body and the portable devices, and the modulator/demodulator circuit. In particular, as this codeless telephone unit employs an analog mode, it is difficult to apply above-mentioned digital voice encryptor to this codeless telephone unit.

As one option to solve these problems, a bluetooth has been used. A bluetooth includes the transmit/receive circuits and the modulator/demodulator both of which are integrated as a single chip. The bluetooth provides a digital communication mode module along with the voice communication. Further, in case that a communication is made between the bluetooths, the communication can be made encrypted. However, as the encryption function provided in the bluetooth is made of software, it could not be applied to an encryption algorithm requiring a high-speed processing.

### SUMMARY OF THE INVENTION

The present invention is contrived to solve the above problems and an object of the present invention is to provide a security codeless telephone unit using bluetooth which allows a safe communication from a wiretapping and secures the activity of a user, wherein the security codeless telephone unit has a bluetooth in a codeless telephone body and a portable device, respectively, to allow voice or data communication module, if a request for switching a security mode is generated from the portable device, voice signals are converted to digital encrypted data via a voice codec, vocoder and an encryption module and data communication module of which is changed from a voice communication module to a data communication module through the bluetooth are then transmitted to the body, and the body that received the digital encrypted data via the bluetooth transmits the digital encrypted data to counterpart codeless telephone unit and body via a network using a data modem.

In order to accomplish the above object, a security codeless telephone unit having a body for transmitting/receiving signals to/from a network connected via lines and a portable device for allowing codeless communication with the body, a codeless telephone unit according to the present invention, is characterized in that it a portable device; and a body, wherein the portable device comprises a first signal converting means for converting analog signals into digital signals or the digital signals into the analog signals, a signal processing means for compressing the digital signals or decompressing the compressed digital signals, an encryption and decompression means for encrypting the compressed digital signals or decompressing the encrypted digital signals, and a first transmitting/receiving means for transmitting/receiving the analog signals and the digital signals, and the body comprises a second signal converting means for converting the analog signals. into the digital signals or the digital signals into the analog signals, a modem for transmitting the encrypted digital signals via the network, a signal recognition means for recognizing the type of the signals received/transmitted to allow the security communication, and a second transmitting/receiving means for transmitting/receiving the analog signals and the digital signals, whereby an encryption communication is performed between the portable device and a counterpart portable device.

In the above, the first and second transmitting/receiving means include a bluetooth having an audio PCM interface for transmitting/receiving the analog signals, and a data interface unit for transmitting/receiving the digital signals. The first and second signal converting means include a voice codec. The signal processing means is a vocoder. The encryption means includes an encryption module. Further, the signal recognition means includes a recognition code transceiver.

A security codeless telephone unit using bluetooth according to the present invention connects a codeless communication period between a codeless telephone body and a portable device through which a digital data communication is allowed, by means of bluetooth. If there is a request for switching a security mode from the portable device or the codeless telephone body, the voice communication is switched to the data communication through bluetooth. The portable device generates encrypted digital data using a voice coder for converting the voice signals into the digital data and an encryption module for encrypting the digital data. Also, the codeless telephone body transmits the encrypted digital data to a network line using a data modem, so that the data can be transmitted to a portable device in a counterpart codeless telephone.

### BRIEF DESCRIPTION OF THE DRAWINGS

The aforementioned aspects and other features of the present invention will be explained in the following description, taken in conjunction with the accompanying drawings, wherein:

FIG. 1 shows a construction of a security codeless telephone unit connected via a network according to the present invention;

FIG. 2 shows a detailed construction of a portable device in FIG. 1;

FIG. 3 shows a detailed construction of a body in FIG. 1;

FIG. 4 is a flowchart for explaining an operation of the portable device in FIG. 2; and

FIG. 5 is a flowchart for explaining an operation of the body in FIG. 2.

### DETAILED DESCRIPTION OF PREFERRED EMBODIMENTS

The present invention will be described in detail by way of a preferred embodiment with reference to accompanying drawings,. in which like reference numerals are used to identify the same or similar parts.

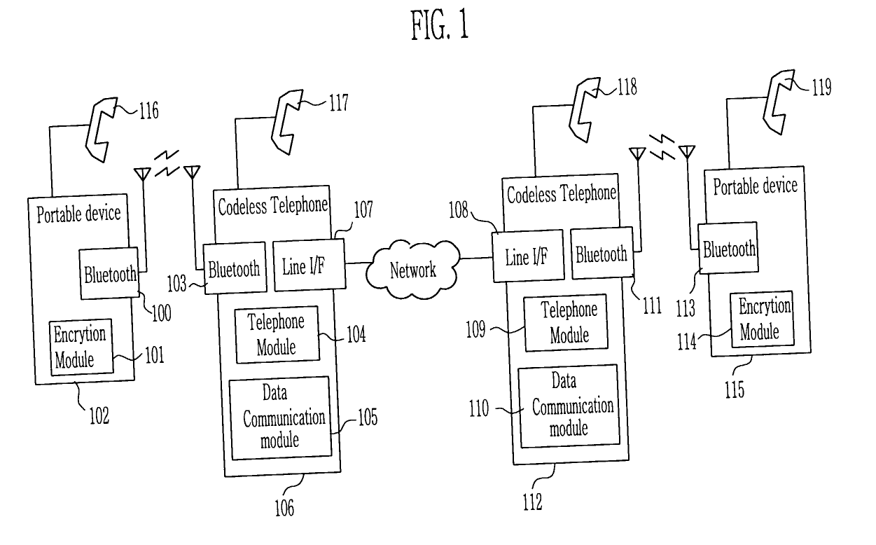

FIG. 1 shows a construction of a system in which the embodiment is applied to network.

As shown in FIG. 1, a security codeless telephone unit using bluetooth includes a codeless telephone body 106,112 and a portable device 102,115. A codeless telephone body 106,112 and the portable device 102,115 is connected by means of bluetooth 100, 103, and 111, 113.

The security codeless telephone unit using bluetooth is characterized in that codeless telephone body 106 and the portable device 102 is connected by the bluetooth 100, 103, an encryption module 101 is mounted in the portable device 102, and the body 106 has a data communication module 105 and telephone module 104.

In order to establish a common communication using the security codeless telephone unit using bluetooth, a microphone in the transceiver 116 of the portable device 102 receives voice. Then, the voice is transmitted to the bluetooth 103 in the body 106 via a voice channel of the bluetooth 100. Next, the voice signal received via the telephone mode module 104 in the body 106 is transmitted to a line interface (I/F) unit 108 in a counterpart codeless telephone body 112 of a telephone mode module state via a line I/F unit 107 and the network. At this time, the line I/F unit may be changed depending on a given network. The received voice is sent to the bluetooth 113 in the portable device 115 via a voice channel of the bluetooth 111 in the body. Then, the voice is outputted via the speaker in the portable device transceiver 119. It should be noted that an opposite path is same to the above procedure.

A path for a security communication is quite different from a common communication. Voice is inputted to the speaker of the transceiver 116 in the portable device 102. Then, the voice is converted to digital signals and is then encrypted by the encryption module 101, so that voice is finally changed to data of a noise shape. Data of the noise shape are transmitted to the bluetooth 103 in the body 106 via the data channel of the bluetooth 100. The body 106 then transmits the voice signals inputted to the data communication module 105 to the line I/F unit 108 of a counterpart codeless telephone body 112 of a data communication module 110, via the line I/F unit 107 and the network. At this time, the line I/F unit may be changed depending on a given network. The received voice is transmitted to the bluetooth 113 in the portable device 115 via the data channel of the bluetooth 111 in the body and is then finally demodulated to be analog voice in the encryption module 114, so that it is transmitted to the speaker of the transceiver 119 of the portable device 115. It should be noted that an opposite path is same to the above procedure.

In these communication procedure, if communication contents are inputted to the transceiver 117 in the body on a sender' side or the transceiver 118 in the body on a receiver' side, or they are wiretapped in the network, data of a noise shape are received or wiretapped.

As mentioned above, data communication is established between the codeless telephone body and the portable device using bluetooth. Thus, digital voice is compressed using a vocoder, so that a voice communication can be established even in the public switched network.

Further, the codeless telephone unit constructed according to the present invention can be used as a common codeless telephone unit or a codeless telephone unit having an encryption function. In other words, the body can be used as a common codeless telephone unit since it has no an encryption function. Only when the portable device calls a security mode, it functions as a relay of the security codeless telephone unit. As all security functions are included in the portable device, the portable device can be used as a common portable device and also used as the security portable device. When the security codeless telephone unit receives data, it functions as a common telephone unit if a counterpart telephone unit is a common telephone unit and functions as a security telephone unit if a counterpart telephone unit is a security telephone unit, depending on a counterpart telephone unit.

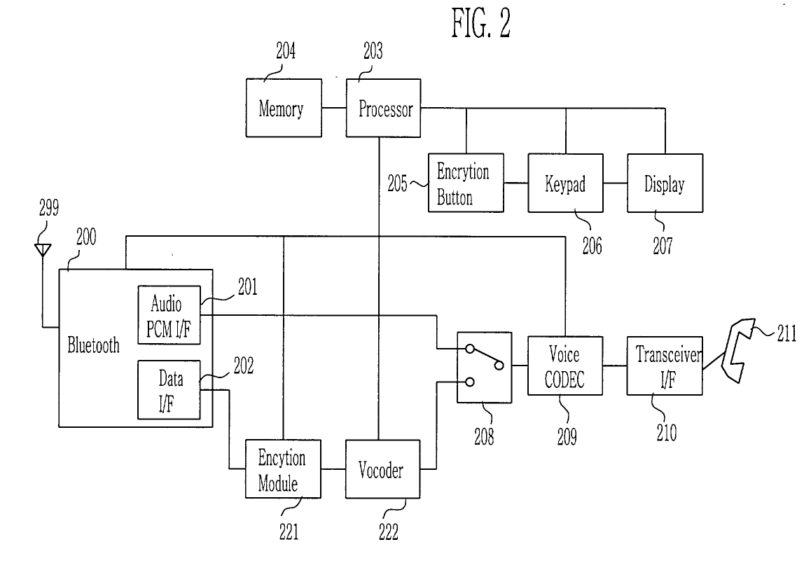

FIG. 2 is a detailed construction of the portable device in FIG. 1.

The portable device 102 or 115 includes an audio PCM interface (I/F) unit 201, a data interface (I/F) unit 202, a processor 203, a memory 204, an encryption button 205, a keypad 206, a display 207, a relay 208, a voice codec 209, an transceiver interface (I/F) unit 210, a transceiver 211, an antenna 299 and a bluetooth 200 for codeless communication with the body, an encryption module 221 for performing an encryption function, and a vocoder 222 for compressing digital voices.

Only a path in the transmission procedure of the portable device will be below described since paths in its transmit/receive procedure are same without regard to the security function operation and only its proceeding direction is opposite.

First, in case of a common voice communication, voice signals are inputted to the transceiver I/F unit 210 via the microphone in the transceiver 211. Then, the voice signals are converted into digital data by means of the voice codec 209. Next, the digital data are transmitted to the body via the audio PCM I/F unit 201 in the bluetooth 200. In case of a security communication, voice signals are inputted to the transceiver interface 210 via the microphone in the transceiver 211. Then, the voice signals are converted to digital data by means of the voice codec 209. Next, the digital data are inputted to the vocoder 222 under the control of relay 208. The vocoder 222 adequately compresses the voice depending on a network line state used, so that a digital voice communication is established even in a narrow-band communication line. The compressed digital signals are then encrypted in the encryption module 211. Next, as the encrypted data are not voice data, they are transmitted to the body via the data interface 202 in the bluetooth 200. A receive procedure is same to the transmit procedure except that the encryption module 211 performs a demodulation process instead of the encryption process and the voice codec 209 performs a digital/analog voice conversion instead of the analog/digital voice conversion. At this time, the data encryption is performed by pressing the encryption button 205 upon transmission and is informed by the body upon reception.

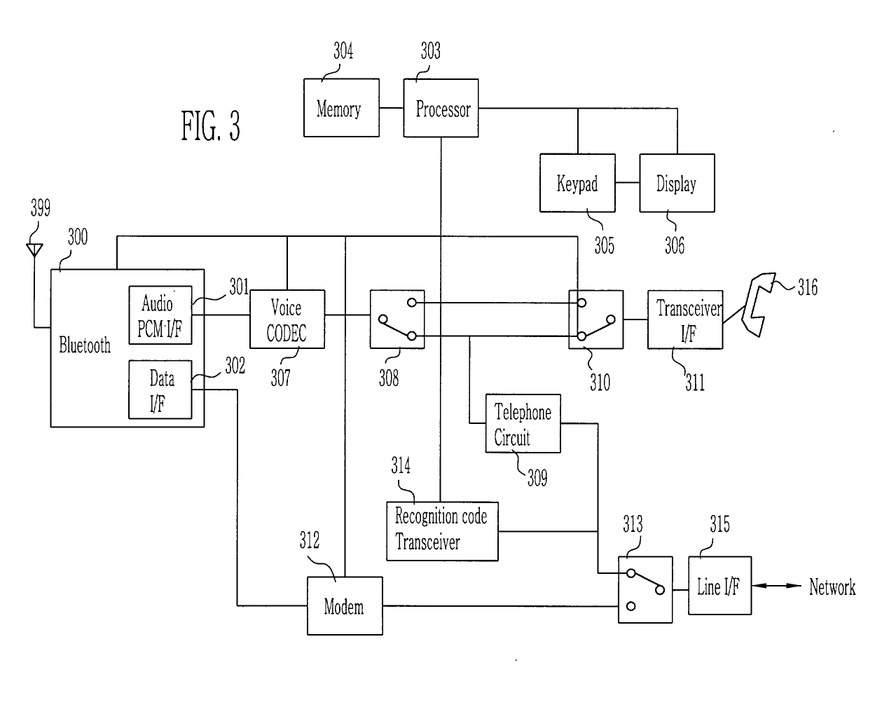

FIG. 3 shows a detailed construction for describing the body of the security codeless telephone unit in FIG. 1.

The codeless telephone body 106 or 112 include a transceiver 316, an interface (I/F) unit 311 in the transceiver, a keypad 305, a display 306, a telephone circuit 309, a line interface (I/F) unit 315, a processor 303, a memory 304, an antenna 399, and a bluetooth 300 for a codeless communication with the portable device, a modem 312 for a data communication, and a recognition code transceiver 314 for receiving/transmitting an encryption mode entry code from/to a counterpart codeless telephone.

An operation of the codeless telephone body 106 or 112 can be classified into a first case that the operation is performed only by the body of the codeless telephone, a second case that the operation is performed in conjunction with the portable device, and a third case that the operation is performed by a security telephone unit.

The first case that the operation is performed only by the codeless telephone body will be first described below.

In the first case, the security operation is not performed. Upon transmission, the transceiver I/F unit 311 in the microphone of the transceiver 316 switches the path to the line I/F unit 315 to transmit voice signals to the network. In this process, the recognition code transceiver 314 does not perform any operation. Upon reception, the same path is taken.

Next, the second case that the operation is performed in conjunction with the portable device will be described below.

Voice signals from the portable device are received through the audio PCM I/F unit 301 in the bluetooth 300. Then, the received voice signals may be transmitted to the portable device via the audio PCM I/F unit 301 in the bluetooth 300. Next, the received voice signals are converted to analog voice signals by the voice codec 307. At this time, if the telephone circuit 309 and the line interface 315 are connected by the two relays 308, 313, the voice signals are transmitted to the network. Even in this case, the recognition code transceiver 314 is not driven. Further, even in case that analog voice signals are received from the network, the path is same to the above path except that the analog voice signals are converted to the digital voice signals in the voice codec 307. There is no security function in an internal communication established between the portable device and the codeless telephone body. The internal communication can be established only if the voice codec 307 and the transceiver interface 311 are connected by means of the two relays 308, 310.

The first and second cases are ones in which the security codeless telephone unit is used as a common telephone unit.

Finally, the third case that the operation is performed by the security telephone unit will be described below.

In the third case, the modem 312 and the line I/F unit 315 are connected by the relay 313. If data encrypted in the portable device are inputted to the data I/F unit 302 in the bluetooth 300, data are transmitted to the network via the modem 312 and the line I/F unit 315. A case of reception is same to the case of transmission. At this time, the recognition code transceiver 314 is driven in setting an initial security mode.

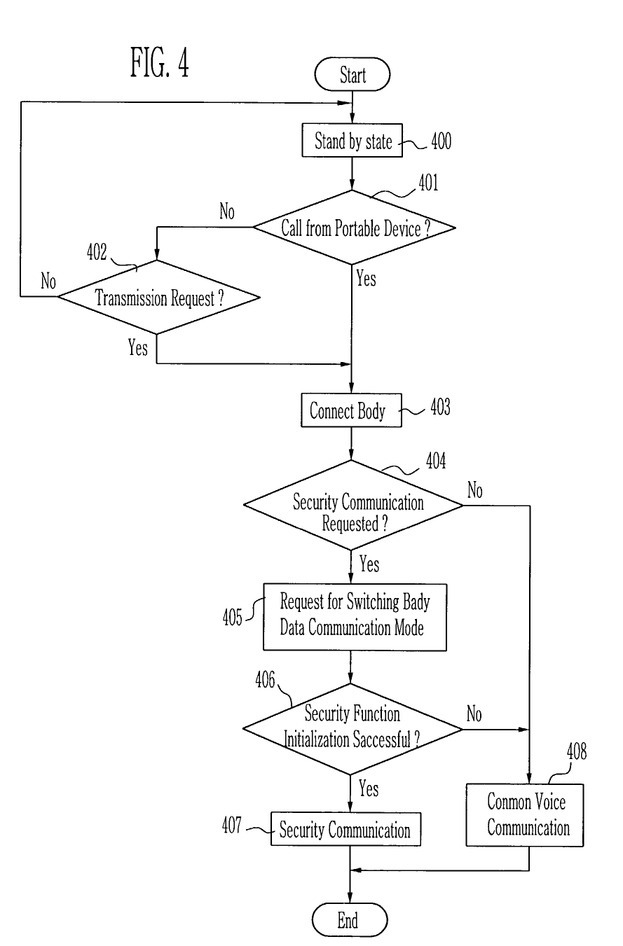

FIG. 4 is a flowchart for explaining an operation of the security codeless telephone portable device according to the present invention.

The portable device monitors that there is a call on the portable device from the codeless telephone body for reception (STEP 401) or there is a request from a user for transmission, that is, off-hook (STEP 402), while maintaining a standby state for a normal communication (STEP 400). If there is the call or the request, the portable device establishes a communication channel with the codeless telephone body (STEP 403). Also, it is determined that there is a request for a security communication (STEP 404). At this time, the security communication can be established as the contents requested by a counterpart is received through the body and can be established by a portable device user's pressure of the encryption button 205 for the security communication. If there was no any request for the security communication, a common voice communication being a non-security communication is established through a common voice communication path (STEP 408). On the other hand, if there was request for the security communication, it is requested that the voice communication mode is switched to the data communication mode between the body and the terminal (STEP 405) and a security function initialization (STEP 406) is then performed. In the security function initialization, whether a counterpart telephone unit has the same security scheme to the portable device is confirmed in addition to an encryption function procedure such as a key exchange, or the quality of the communication line is conformed. If entry into the security mode fails, it is determined that the communication is finished or the communication is switched to a common voice communication (STEP 408), if necessary. If the security function initialization is successful, the security communication is established (STEP 407).

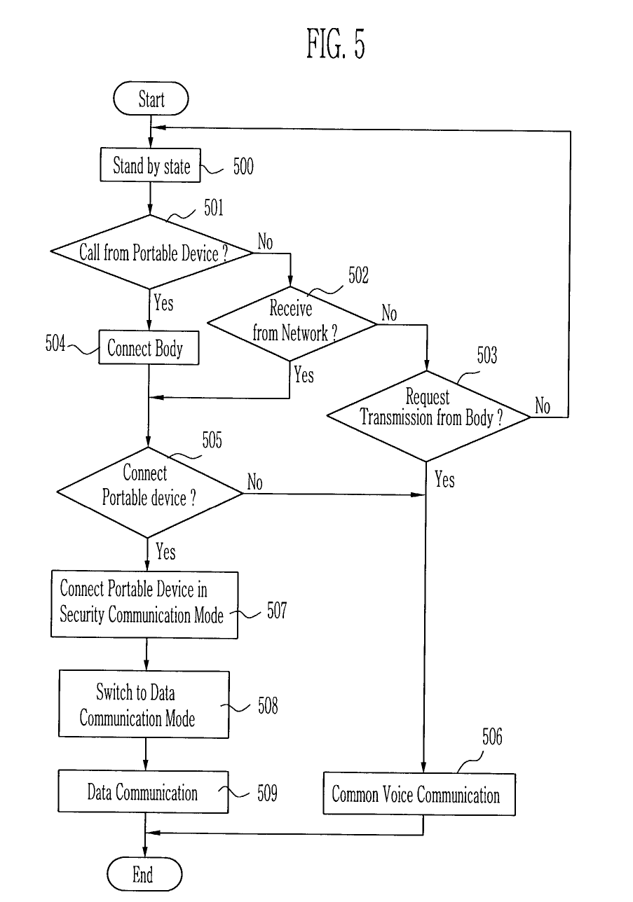

FIG. 5 is a flowchart for explaining an operation of the security codeless telephone body according to the present invention.

The body monitors that there is a call on the body from the portable device for transmission (STEP 501), a call has been received from a counterpart via the network (STEP 502) or a user give a request for transmission using the body, that is, off-hook, while maintaining a standby state for communication (STEP 500). If the body requested a transmission (STEP 503), a common voice communication is established (STEP 506) since the security communication mode is not supported. On the other hand, if the body is called (STEP 501) or a call is received (STEP 502), it must be conformed that there is a request for the security communication (STEP 505). As a result of the confirmation, if there is no request for the security communication (STEP 505), the common voice communication is established (STEP 506). On the other hand, if there is a request for the security communication (STEP 505), the codeless telephone body and the portable device are connected in a security mode (STEP 507). As the security mode is a data communication, it is converted to a data communication mode along with the codeless telephone body (STEP 508) so that the data communication is performed (STEP 509). In the process of switching to the security mode, the body does not any operation related to encryption. The body transmits data from the portable device via the network and transmits the received data to the portable device. At this time, connection of the portable device (STEP 504) and the security mode connection of the portable device (STEP 507) are performed by the difference in the voice mode connection and the data mode connection.

U.S. Pat. No. 5,963,621 discloses ‘Security Communication Service’. This patent provides a system for supporting a serial interface of STU-III (Secure Terminal Unit-III). STU-III is a security equipment that is used in a digital mobile communication environment of a low transmission speed used by a security communication service and U.S.A government. An object of this patent is to protect voice data of the voice communication equipment using a satellite communication network Inmarsat-B and Inmarsat-M channel as well as the security equipment using PSTN, by including a system related to the security equipment in the digital communication environment and a system for supporting STU-III being a digital system of a low transmission speed including the mobile communication system. The security communication service in this patent is only applied to the wire telephone unit. On the contrary, the present invention relates a technology of simultaneously having a codeless telephone function and a wire/codeless telephone function using bluetooth.

Korean Patent Publication No. 1997-0072042 discloses' Digital Voice-Dedicated Telephone for Common Public Switching Network and Telephone Connection Method Using the Same'. In particular, this patent relates to the digital voice-dedicated telephone unit having a circuit for performing a control process in which a modem, a digital voice compression device, a control processor, etc. are included in order to allow communication of a digital voice in the public switching network. This patent only disclose a digital wire telephone unit to be used in the public switching network but does not disclose a codeless telephone unit.

Korean Patent Publication No. 997-038844 discloses ‘Codeless Phone Capable of Repulsing Making a Phone Call for Fun Using Encryption Function and Method Thereof’. The codeless phone includes a portable device and a fixed device both of which have an encryption function. The encryption function is usually called scramble, which codes or encrypts given signals in a given method so that a receiver could not be understood. This patent discloses the encryption function between the codeless phone and the portable drive in order to repulse making a phone call for fun.

Japanese Patent Publication No. 88-8480 discloses ‘Codeless Phone Unit’. This patent relates the codeless telephone unit that allows an extension communication between the codeless telephone and the wire telephone in addition to external communication but does not allow wiretapping of communication during the external communication. Therefore, this patent only protects a codeless period between the codeless telephone body and the portable device and employs analog voice.

As mentioned above, the present invention has outstanding advantages that it can fully protect a wiretapping during communication and improve the efficiency and stability of work by providing a security function in addition to the communication service same to an existing common codeless telephone.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1 A security codeless telephone unit having a body for transmitting/receiving signals via network lines and a portable device for allowing codeless communication with the body,
Wherein said portable device comprises:
a first signal converting means for converting analog signals into digital signals or the digital signals into the analog signals,
a signal processing means for compressing the digital signals or decompressing the compressed digital signals,
an encryption and decompression means for encrypting the compressed digital signals or decompressing the encrypted digital signals, and
a first transmitting/receiving means for transmitting/receiving the analog signals and the digital signals,
and wherein said body comprises:
a second signal converting means for converting the analog signals into the digital signals or the digital signals into the analog signals,
a modem for transmitting the encrypted digital signals via the network,
a signal recognition means for recognizing the type of the signals received/transmitted to allow the security communication, and
a second transmitting/receiving means for transmitting/receiving the analog signals and the digital signals,
whereby an encryption communication is performed between the portable device and a counterpart portable device.

2. The security codeless telephone unit as claimed in claim 1, wherein said first and second transmitting/receiving means include a bluetooth having an audio PCM interface for transmitting/receiving the analog signals, and a data interface unit for transmitting/receiving the digital signals.

3. The security codeless telephone unit as claimed in claim 1, wherein said first and second signal converting means include a voice codec.

4. The security codeless telephone unit as claimed in claim 1, wherein said signal processing means is a vocoder.

5. A security codeless telephone unit using bluetooth, including a body having a transceiver, a keypad, a processor having a memory, a telephone circuit for allowing a voice communication and a line interface for transmitting/receiving signals via network line, and a portable device for allowing a codeless communication with the body having a transceiver, a keypad and a processor having a memory,
wherein said body further comprises:
a bluetooth for transmitting/receiving analog signals and digital signals via an antenna,
a voice codec connected between said bluetooth and said telephone circuit, for converting the analog signals into the digital signals or the digital signals into the analog signals,
a modem connected between said bluetooth and said line interface, for transmitting the digital signals, and
a recognition code transceiver connected between said processor and said line interface, for recognizing the type of the signals transmitted/received,
said portable device further comprises:
a bluetooth for transmitting the analog signals and the digital signals via an antenna,
a voice codec connected between said bluetooth and said transceiver, for converting the analog signal into the digital signals or the digital signals into the analog signals,
an encryption module connected to said bluetooth, for encrypting and decompressing the encrypted digital signals,
a vocoder connected to said processor, for compressing the signals from the voice codec and transmitting the compressed signals to said encryption module, and
an encryption button connected to said processor, for receiving a command for an encryption communication.

6. The security codeless telephone unit using bluetooth as claimed in claim 5, wherein said bluetooth includes audio PCM interface for transmitting/receiving the analog signals, and a data interface for transmitting/receiving the digital signals.

7. The security codeless telephone unit using bluetooth as claimed in claim 5, wherein said portable device further includes a relay for connecting the audio PCM interface in said bluetooth or said vocoder to said voice codec depending on a communication mode.

8. The security codeless telephone unit using bluetooth as claimed in claim 5, wherein said body further includes:
a first relay for connecting said line interface to said telephone circuit or said modem in said recognition code transceiver depending on the type of the signals transmitted/received,
a second relay for connecting said voice codec and said telephone circuit, and
a third relay for connecting said transceiver and said telephone circuit.
